(19) United States
(12) Patent Application Publication
(10) Pub. No.: US 2022/0122025 A1
(43) Pub. Date: Apr. 21, 2022

(54) Software development task effort estimation

(71) Applicant: ACUMEN LABS LTD., Tel Aviv (IL)

(72) Inventor: Idan Amit, Ramat Gan (IL)

(21) Appl. No.: 17/070,941

(22) Filed: Oct. 15, 2020

(51) Int. Cl. G06Q 10/06; G06F 8/77

(52) U.S. Cl. CPC G06Q 10/063118; G06F 8/77

(57) ABSTRACT

Methods, apparatuses and computer program products implement embodiments of the present invention that include selecting, from a source code management system, a set of software tasks completed by a plurality of developers, each of the tasks indicating a single unit of work in a software project. Upon selecting the set of software tasks, information for each given completed software task is retrieved from the source code management system. Upon receiving a time estimation request for a new software task, the retrieved information and the received request are modeled so as to compute a time estimate for the new software task. In embodiments of the present invention, the time estimation request includes an identifier for a given developer and one or more additional parameters. Finally, the computed time estimate is reported in response to the request.

### FIELD OF THE INVENTION

The present invention relates generally to software development task effort estimation, and particularly to deploying a task effort estimation model that was generated from data on previously completed software tasks.

### BACKGROUND OF THE INVENTION

Effort estimation is the process used to predict the amount of effort (e.g., developer hours) needed to develop a software application. The predicted amount of effort can then be used as basis for predicting project costs and for determining an optimal allocation of software developer time. An estimate for a new project can be typically derived by considering characteristics of the new project as well as characteristics of previous similar projects.

The description above is presented as a general overview of related art in this field and should not be construed as an admission that any of the information it contains constitutes prior art against the present patent application.

### SUMMARY OF THE INVENTION

There is provided, in accordance with an embodiment of the present invention, a method including selecting, from a source code management system, a set of software tasks completed by a plurality of developers, each of the tasks including a single unit of work in a software project, retrieving, from the source code management system, information for each given completed software task, receiving a time estimation request for a new software task, the time estimation request including an identifier for a given developer and one or more additional parameters, modeling, by a processor, the retrieved information and the received request so as to compute a time estimate for the new software task, and reporting the computed time estimate in response to the request.

In one embodiment, the task type includes a new system feature for the software project.

In another embodiment, the task type includes a refactor for the software project.

In an additional embodiment, the task type includes a software patch to fix a bug for the software project.

In a further embodiment, the source code management system includes a version control system, and wherein the software tasks completed by a plurality of developers include commits.

In some embodiments, the method also includes retrieving, from a task management system, additional information for a plurality of the software tasks, and wherein modeling the retrieved information includes modeling the retrieved additional information.

In a supplemental embodiment, the source code management system includes a task management system.

In some embodiments, the method also includes identifying one or more of the completed software tasks that were stored to the source code management system by a bot, and excluding the identified one or more completed software tasks from the modeling of the retrieved information.

The additional embodiments, the method also includes identifying one or more of the completed software tasks that include merged completed software tasks, and excluding the identified one or more completed software tasks from the modeling of the retrieved information.

In other embodiments, the method also includes classifying one or more of the developers that are not full-time employees (FTEs), identifying one or more of the completed software tasks that were submitted by the one or more developers classified as a non-FTE, and excluding the identified one or more completed software tasks from the modeling of the retrieved information.

In one embodiment, modeling the retrieved information and the received request so as to compute the time estimate for the new software task includes computing, for the given developer, a task completion duration for the tasks completed by the given developer, and computing one or more productivity metrics based on the computed task completion durations, and wherein the time estimate is based on the one or more computed productivity metrics.

In some embodiments, computing a given task completion duration for a given task includes identifying a most recent previous software task completed by the given developer, and computing an amount of time between the given task and the identified most recent task.

In another embodiment, modeling the retrieved information and the received request so as to compute the time estimate for the new software task includes determining a corrective commit probability (CCP) quality metric for a given developer, and wherein the time estimate is based on the CCP metric.

In an additional embodiment, modeling the retrieved information and the received request so as to compute the time estimate for the new software task includes computed an average number of components in the tasks completed by the developer, and wherein the time estimate is based on the computed average.

In a further embodiment, a given parameter includes an identity of a component to be modified in the new software task, and wherein modeling the retrieved information and the received request so as to compute the time estimate for the new software task includes identifying a time when a most recent task including the given component that was completed by the developer, and wherein the time estimate is based on the identified time.

In a further embodiment, a given parameter includes an identity of a component to be modified in the new software task, and wherein modeling the retrieved information and the received request so as to compute the time estimate for the new software task includes identifying a number of the tasks including the given component that were completed by the developer, and wherein the time estimate is based on the identified number of the tasks.

In a supplemental embodiment, a given parameter includes an estimated task size, and wherein modeling the retrieved information and the received request so as to compute the time estimate for the new software task includes computing respective task completion durations and corresponding task sizes for the completed tasks, and wherein the time estimate is based on the estimated task size, the computed task completion durations and the corresponding task sizes.

In one embodiment, a given parameter includes an assigned task type, and wherein modeling the retrieved information and the received request so as to compute the time estimate for the new software task includes computing respective task completion durations and corresponding task types for the completed tasks, and wherein the time estimate is based on the assigned task type, the computed task completion durations and the corresponding task types.

In another embodiment, the new software task belongs to a project including one or more of the completed tasks, and wherein modeling the retrieved information and the received request so as to compute the time estimate for the new software task includes computing a code reuse metric for the one or more completed tasks, and wherein the time estimate is based on the computed code reuse metric.

In another embodiment, the new software task belongs to a project including a subset of the completed tasks, and wherein modeling the retrieved information and the received request so as to compute the time estimate for the new software task includes identifying, a number of the tasks in the subset that include bug fixes, and wherein the time estimate is based on the identified number of the tasks.

In an additional embodiment, the new software task belongs to a project including a subset of the completed tasks, and wherein modeling the retrieved information and the received request so as to compute the time estimate for the new software task includes identifying, in the subset, a number of components, and wherein the time estimate is based on the identified number of the components.

In a further embodiment, a given parameter includes an identity of a component to be modified in the new software task, and wherein modeling the retrieved information and the received request so as to compute the time estimate for the new software task includes identifying one or more additional components similar to the component to be modified, and wherein the time estimate is based on the identified one or more additional components.

There is also provided, in accordance with an embodiment of the present invention, a computer system including a memory configured to store a source code management system including multiple software tasks completed by a plurality of developers, each of the tasks including a single unit of work in a software project, and one or more processors configured to select a set of the completed software tasks, to retrieve, from the source code management system, information for each given completed software task, to receive a time estimation request for a new software task, the time estimation request including an identifier for a given developer and one or more additional parameters, to model the retrieved information and the received request so as to compute a time estimate for the new software task, and to report the computed time estimate in response to the request.

There is additionally provided, in accordance with an embodiment of the present invention, a computer software product for protecting a computing system, the product including a non-transitory computer-readable medium, in which program instructions are stored, which instructions, when read by a computer, cause the computer to select, from a source code management system, a set of software tasks completed by a plurality of developers, each of the tasks including a single unit of work in a software project, to retrieve, from the source code management system, information for each given completed software task, to receive a time estimation request for a new software task, the time estimation request including an identifier for a given developer and one or more additional parameters, to model the retrieved information and the received request so as to compute a time estimate for the new software task, and to report the computed time estimate in response to the request.

### BRIEF DESCRIPTION OF THE DRAWINGS

The disclosure is herein described, by way of example only, with reference to the accompanying drawings, wherein:

FIG. 1 is a block diagram that schematically illustrates a computer system comprising a task effort estimation model, in accordance with an embodiment of the present invention;

FIG. 2 is a block diagram that schematically illustrates a completed task data record configured to store task data retrieved from a version control system, in accordance with an embodiment of the present invention;

FIG. 3 is a block diagram that schematically illustrates a ticket record configured to store task data retrieved from a task management system, in accordance with an embodiment of the present invention;

FIG. 4 is a block diagram that schematically illustrates a task profile used by the task effort estimation model, in accordance with an embodiment of the present invention;

FIG. 5 is a block diagram that schematically illustrates a developer profile used by the task effort estimation model, in accordance with an embodiment of the present invention;

FIG. 6 is a block diagram that schematically illustrates a project profile used by the task effort estimation model, in accordance with an embodiment of the present invention;

FIG. 7 is a block diagram that schematically illustrates a component profile used by the task effort estimation model, in accordance with an embodiment of the present invention;

FIG. 8 is a block diagram that schematically illustrates a context profile used by the task effort estimation model, in accordance with an embodiment of the present invention;

FIG. 9 is a flow diagram that schematically illustrates a method for generating the task effort estimation model, in accordance with an embodiment of the present invention; and

FIG. 10 is a flow diagram that schematically illustrates a method for using the task effort estimation model, in accordance with an embodiment of the present invention.

### DETAILED DESCRIPTION OF EMBODIMENTS

Effort estimation is an important aspect of project planning. The importance of effort estimation has increased in software development as human effort has a large impact on software development cost. Embodiments of the present invention provide methods and systems for estimating an amount of software development effort required to complete a software task. In embodiments described herein, the estimation of effort comprises a time estimate.

As described hereinbelow, a set of software tasks completed by a plurality of developers are selected from one or more source code management systems, and information for each given completed software task is retrieved from the one or more source code management systems. In embodiments described herein, each of the tasks comprises a single unit of work in a software project. In other words, the software project can be defined as a set of tasks that when completed, accomplish a single outcome or goal.

A task can be defined as a unit of work that a single developer can complete in a single defined period (e.g., a workday). In some embodiments, a task can be split into smaller subtasks for easier tracking & completion of the parent task. A project, on the other hand, has wider impact and higher risks, and typically needs planning for resources and schedule with a team.

Each given task typically has an end goal beyond its own completion. As described hereinbelow, a single unit of work may comprise a single new system feature for a software project, a single bug fix to correct a bug in the software project or a single refactor for the software project. For example, if the software project comprises an image database, then:
An example of a new system feature may comprise a data entry screen in which a user can add a description for a given image in the database.
An example of a bug may comprise the image database associating comments with the wrong images, and the bug fix comprises correcting the wrong associations.
A refactor comprises a change to code that improves the efficiency of a code. For example, a refactor may comprise a faster (i.e., more efficient) sort algorithm or a faster search algorithm.

Upon receiving a time estimation request for a new software task assigned to a given developer, the time estimation request comprising one or more parameters, the retrieved information and the received request are modeled so as to compute a time estimate for the new software task. Finally, the computed time estimate can be reported in response to the received request.

As opposed to performing effort estimation on the project level, embodiments of the present invention can perform effort estimation at a single task level, which can be represented by a commit in a given source code management system. This is because project effort estimation may only be needed at most few times per project, while a task effort is typically part of the daily software development. Working at the task level allows use of large and up-to-date data sources, avoiding the need to collect manually information on projects.

Systems implementing embodiments of the present invention can investigate the gross time needed to complete a task (i.e., as opposed to the net-time). One reason for this is that data used by embodiments described herein to compute task time durations includes work interruptions such as coffee breaks, weekends, and vacation. While some of these periods are easy to identify and remove (e.g., weekends), the result may only be partial, and the data can become contaminated with biases and processing. Another reason is that since work interruptions will typically be part of future tasks, they should be considered when computing time estimates.

### System Description

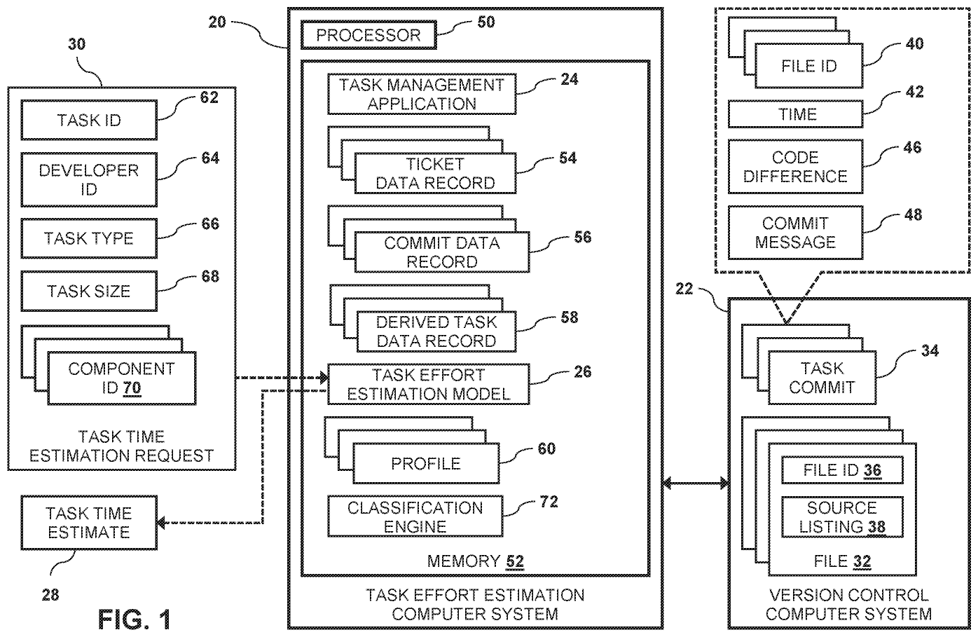

FIG. 1 is a block diagram that schematically shows an example of a task effort estimation computer system 20 that is configured to use data from a source code management system comprising version control computer system 22 and a second task management system application 24, so as to generate and deploy a task effort estimation model 26, in accordance with an embodiment of the present invention. In some embodiments, task effort estimation model 26 may comprise a set of rules (not shown). Typically, source code management application 24 operates independently from version control computer system 22. In embodiments described herein, task effort estimation model 26 is configured to compute and convey a task time estimate 28 in response to receiving a task time estimation request 30.

Computer system 20 is configured to communicate with version control computer system 22 (e.g., via a public network such as the Internet) that is configured to manage source code development and code adaptation for software tasks. An example of version control computer system 22 is GITHUB™, produced by Microsoft Corporation, Redmond, Wash., USA.

In the configuration shown in FIG. 1, version control computer system 22 stores respective sets of files 32 and task commits 34. In embodiments described herein, each given task commit 34 references a corresponding completed software task. In embodiments herein, task commits 34 may be referred to simply as tasks 34 or commits 34. As described supra, a given task may comprise a new system feature, a bug fix or a refactor. In a first embodiment where version control system 22 comprises GITHUB™, each task commit 34 may reference a single task. In a second embodiment where version control system 22 comprises GITHUB™, each task commit 34 may reference a few tasks. For example, in the second embodiment, a single task commit 34 may reference one or more bug fixes and a refactor.

While embodiments herein describe using task commits 34 that can be retrieved from GITHUB™, using data from other public repository systems is considered to be within the spirit and scope of the present invention. For example, processor 50 can extract the information (described hereinbelow) for task commits 34 from “issues” stored in JIRA™, produced by Atlassian Corporation Plc, Sydney, Australia.

Each given file 32 may comprise a file identifier (ID) 36 (e.g., a file name) and a source listing 38 comprising source code.

Each given commit 34 may store:
One or more file IDs 40 indicating any files 32 that were updated in the given commit. A given file ID 40 can reference a given file 32 by storing the respective file ID 36 for the given file.
A commit time 42 indicating a date and time of the given commit.
A code difference 46 (also known as code diff) comprising changes to one or more of the files referenced by the one or more file IDs in the given commit.
A commit message 48 comprising a description for the given commit. For example, the commit message can indicate that the changes to the source code in the given commit were a new system feature, a refactor or a bug fix.

Computer system 20 comprises a processor 50 and a memory 52 that stores task management system application 24 (e.g., “GITHUB ISSUES™”, produced by Microsoft Corporation, Redmond, Wash., USA). In some embodiments, processor 50 can execute task management system application 24 so as to help complete projects more efficiently by organizing sets of tasks. Task management system application 24 can store information on the tasks to ticket data records 54. Ticket data records 54 are described in the description referencing FIG. 3 hereinbelow.

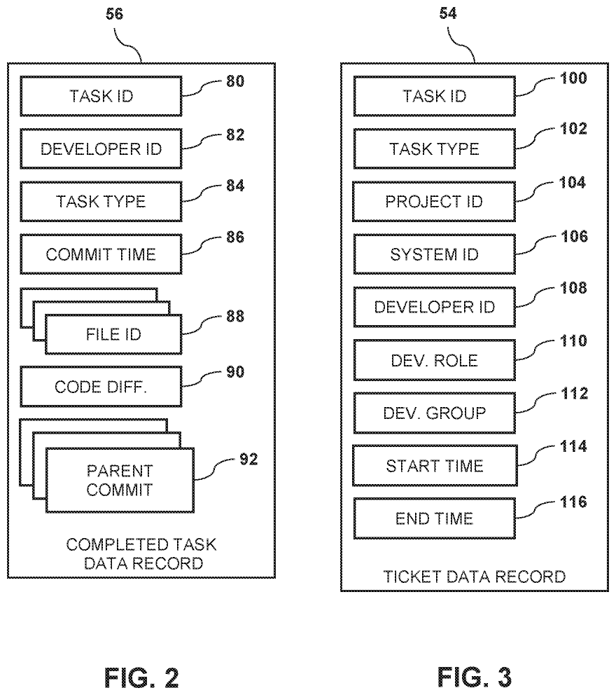

Memory 52 also stores a set of completed task data records 56. Completed task data records 56 store information extracted from corresponding task commits 34 and are described in the description referencing FIG. 2 hereinbelow.

In the configuration shown in FIG. 1, memory 52 stores a classification engine 72. In some embodiments, classification engine 72 can analyze feature variables (i.e., the information stored in profiles 60) that processor 50 stores into profiles 60, and can generate build task effort estimation model 26 based on the analysis. Examples of algorithms that classification engine 72 can use to build task effort estimation model 26 may comprise a supervised learning algorithm such as a decision tree, a random forest, a logistic regression, or a neural network.

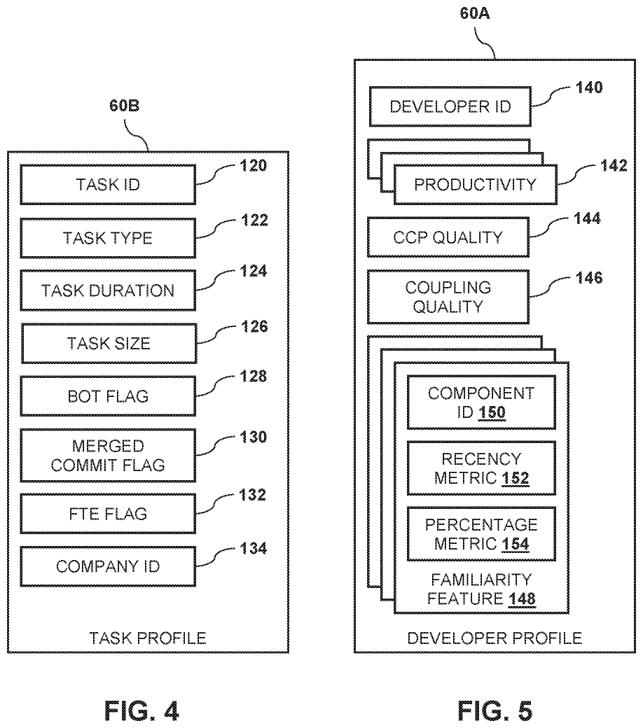

In embodiments of the present invention, task effort estimation model 26 that uses multiple profiles 60. Examples of profiles 60 are described in the description referencing FIGS. 4-8 hereinbelow.

As described supra, task effort estimation model 26 is configured to process task time estimation requests 30. Each given task time estimation request 30 for a new task may comprise new task feature variables such as:
A unique new task identifier (ID) 62. Embodiments described herein analyze multiple software tasks, wherein each of the tasks has a corresponding task ID (e.g., task ID 62).
A developer ID 64. Embodiments described herein analyze multiple software developers, wherein each of the developers has a corresponding developer ID (e.g., ID 64).
An assigned task type 66. Examples of the task type include, but are not limited to a new system feature, a refactor and a bug fix.
A predicted task size 68. The predicted task size indicates an amount of time needed to perform the new task. In some embodiments, processor 50 can use a manageable number of different sizes when classifying task sizes 68 for tasks 34. For example, processor 50 can classify tasks 34 as either small, medium and large (i.e., and store those classifications to task sizes 68), as described hereinbelow.
One or more component IDs 70. Embodiments of the present invention analyze the use of components in software tasks, wherein each of the components has a corresponding component ID (e.g., component ID 70) Examples of component IDs include, but are not limited to source code files 32, projects (i.e., comprising multiple tasks) and systems (e.g., an accounting system), a location (e.g., a server or a directory) to store source code files, or a device (e.g., a server).

Processor 50 may comprise a general-purpose central processing unit (CPU) or a special-purpose embedded processor, which is programmed in software or firmware to carry out the functions described herein. This software may be downloaded to computer system 20 in electronic form, over a network, for example. Additionally or alternatively, the software may be stored on tangible, non-transitory computer-readable media, such as optical, magnetic, or electronic memory media. Further additionally or alternatively, at least some of the functions of processor 50 may be carried out by hard-wired or programmable digital logic circuits.

Examples of memory 52 include dynamic random-access memories and non-volatile random-access memories such as hard disk drives and solid-state disk drives.

In some embodiments, the respective functionalities of task management application 24 and generating and deploying task effort estimation model 26 may be split among multiple computing systems 20. In some embodiments, the functionality of some or all of computing systems 20 and 22 may be deployed as virtual machines in any given computing system and/or a cloud computing facility.

FIG. 2 is a block diagram that schematically illustrates an example of a given completed task data record 56, in accordance with an embodiment of the present invention. In some embodiments, processor 50 can retrieve a given commit 34, analyze the information in the given commit and store the following information to a corresponding completed task data record 56:
A task ID 80 referencing a given task 34. Processor 50 can extract task ID 80 from the commit message in the given commit.
A developer ID 82 referencing a given developer. Processor 50 can extract developer ID 82 from the commit message in the given commit.
A task type 84. Processor 50 can extract task type 84 from the commit message in the given commit.
A commit time 86 comprising time 42 of the given commit.
One or more file IDs 88 comprising the one or more file IDs 40 in the given commit.
A code difference 90 comprising code difference 46 in the given commit.
One or more parent commits 92 referencing one or more respective commits 34 on which the given commit is based.
   In some embodiments, processor 50 can use one or more techniques such as linguistic analysis to extract information (e.g., developer ID 82, task type 84 and task ID 80) from commit messages 48. Examples of how processor 50 can use linguistic analysis can be found in:
I. Amit and D. G. Feitelson. The Corrective Commit Probability Code Quality Metric. ArXiv, abs/2007.10912, 2020.
I. Amit et al. 2019. Which Refactoring Reduces Bug Rate? PROMISE'19: Proceedings of the Fifteenth International Conference on Predictive Models and Data Analytics in Software Engineering. Pages 12-15.

FIG. 3 is a block diagram that schematically illustrates an example of a given ticket data record 54, in accordance with an embodiment of the present invention. In embodiments comprising ticket management system application 24, information in ticket data records 54 are typically input manually (at some point), and a given ticket data record 54 can store information such as:
A task ID 100 referencing a given task 34.
A task type 102 for the task.
A project ID 104 referencing a given project that includes the task.
A system ID 106 referencing a given system for which the task was performed.
A developer ID 108 referencing a given developer.
A developer role 110 indicating a role (e.g., full-stack developer, manager) of the given developer.
A developer group 112 indicating a group or department in the company.
A start time 114 indicating a date and time when the given developer started the task.
An end time 116 indicating a date and time when the given developer completed the task.

FIGS. 4-8 are block diagrams that schematically illustrate examples of profiles 60, in accordance with an embodiment of the present invention. In FIGS. 4-8, profiles 60 can be differentiated by appending a letter to the identifying numeral, so that the profiles comprise developer profiles 60A, task profiles 60B, project profiles 60C, component profiles 60D and context profiles 60E. In embodiments described herein, each given developer has a corresponding developer profile 60A, each given task commit 34 has a task profile 60B, each given project ID 104 has a corresponding project profile 60C, each given component has a corresponding component profile 60D, and each identified combination of a given developer and a given component has a corresponding context profile 60E.

Task profiles 60B comprise information that processor 50 extracts and computes from respective commits 34. In some embodiments, task profiles 60B can also store information that processor 50 extracts from respective ticket data records 54.

In the configuration shown in FIG. 4, each given task profile 60B corresponds to a given task 34. In embodiments where there exists a corresponding ticket data record 54 for a given completed task data record 56 (e.g., where the task ID in the ticket data records matches the task ID in the completed task data record), processor 50 can populate a given task profile 60B with information derived from both of the records. However, if there is no corresponding ticket data record 54 for a given completed task data record 56, then processor 50 can populate a given task profile 60B with information derived solely from the given completed task data record.

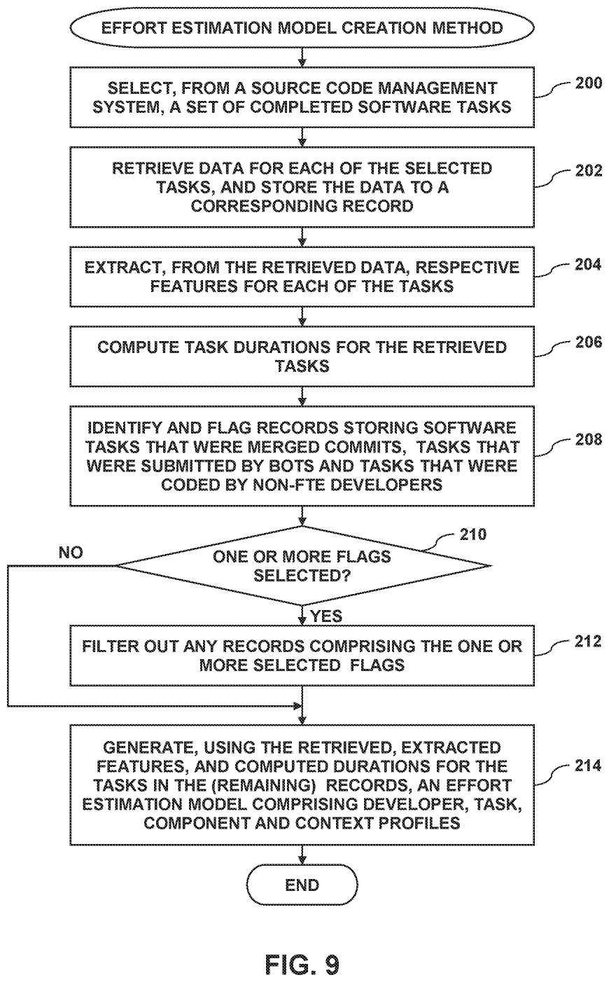

Each given task profile 60B can store feature variables such as:
A task ID 120 comprising task ID 80 (i.e., in a given completed task data record 56) that indicates a given task 34.
A task type 122. In embodiments where there is a corresponding ticket data record 54 for task ID 120 (i.e., where task ID 100 matches task ID 120), task type 122 can comprise the task type in the corresponding ticket data record. Otherwise, task type 122 can comprise task type 84 from the given completed task data record (i.e., where task ID 100 matches task ID 120).
A task completion duration 124 (also referred to herein simply as task duration 124) indicating an amount of time it took the developer to perform the task. In one embodiment where there is a corresponding ticket data record 54 for task ID 120, processor 50 can subtract start time 114 from end time 116 in the corresponding ticket data record to compute task duration.
However, in another embodiment where there is no corresponding ticket data record 54 for task ID 120, processor 50 can compute task duration 124 by (a) identifying the developer ID and the commit time in the given completed task data record, (b) identifying the most recent previous completed task data record 56 whose respective developer ID 82 matches the developer ID in the given completed task data record, and (c) subtracting the commit time in the identified completed task data record from the commit time in the given task. In this embodiment, processor 50 may only compute task duration 124 if the commit times in the given and identified completed task data records comprised identical dates (i.e., in order to filter out the task durations that included “non-working hours”).
A task size 126. Processor 50 can derive task size 126 from task duration 124, as described hereinbelow.
A bot flag 128. Detecting bots and setting bot flag 128 is described in the description referencing FIG. 9 hereinbelow.
A merged commit flag 130. Processor 50 can analyze the commit message in a given commit 34 corresponding to a given completed task data record 56 so as to identify any parent commits 34 for the given commit. Processor 50 can set merged commit flag 130 if there is more than one parent commits 34 for the given commit.
A full-time employee (FTE) flag 132. Detecting FTEs and non-FTEs and setting FTE flag 132 is described in the description referencing FIG. 9 hereinbelow.
A company ID 134 referencing a company that employs or contracts the given developer. In one embodiment, processor 50 can identify company ID 110 as the owner of the project comprising the given task.

For each given task profile 60B processor 50 can locate a corresponding completed task data record 56 by identifying a given task ID 80 matching the given task ID 120, and can locate a corresponding ticket data record 52 by identifying a given task ID 100 matching the given task ID 120. Upon locating the corresponding records, processor 50 can extract feature variables (e.g., file ID 88 and project ID 106) for the given task profile (i.e., in addition to feature variables 120-134).

To generate developer profiles 60A, processor 50 can identify a set of unique developer IDs 82 in completed task data records 56, and generate, based on information stored in ticket data records 54, completed task data records 56 and task profiles 60B, respective developer profiles 60A for each of the unique developer IDs. As shown in FIG. 5, each developer profile 60A may comprise feature variables such as:
A developer ID 140 for a given developer.
One or more productivity metrics 142. Each productivity metric 142 can indicate an average duration or a mean duration of tasks performed by the developer (i.e., as indicated by task durations 124 in task profiles 60B and developer IDs 82 in completed task data records 56, wherein processor 50 can match task profiles 60B to completed task data records 56 by matching task IDs 80 to task IDs 120). Since different developers finish tasks at different speeds, the productivity metric of the given developer for past tasks can indicate the given developer's productivity (i.e., speed) for future tasks.
A task corrective commit probability (CCP) quality metric 144. Task CCP quality metric 144 can indicate how many of the tasks in components owned by the given developer are bug fixes. The rationale for this is that if the given developer has performed a high number of bug fixes in components owned by the given developer, then components owned by the given developer will probably have many bug fixes in the future as well. In embodiments herein, a given developer can be considered to “own” a component if the given developer is responsible for the given component or if the given developer authored a significant portion (e.g., at least half) of code differences 46 for the given component.
One description of the CCP quality metric can be found in Amit, I et al., “The Corrective Commit Probability Code Quality Metric” cited supra.
A task coupling quality metric 146. Task coupling quality metric 146 can indicate an average number of components (e.g., files 32) are used in the tasks (i.e., referenced by task IDs 80) performed by the given developer. The rationale for this metric is that the size of a given task 34 is related to the number of components in the given task. This is because tasks with more components typically require more time to complete, since any update to one of the components may necessitate an update to other components in the tasks.

In addition to feature variables 140-146, each developer profile 60A can store one or more familiarity feature variables 148 that can indicate the given developer's familiarity with a given component (e.g., a given file, a given project or a given system). The rationale for familiarity feature variables 148 is that a developer will typically require less time to complete a new task comprising a recently used component than a new task comprising a component that was not used recently, which may require the developer to reacquaint himself/herself with the component.

In one embodiment, the familiarity feature variable for a given component can indicate how long it has been (i.e., recency) since the developer worked on a task comprising the given component. In another embodiment, the familiarity feature variable for a given component can indicate how much (i.e., a percentage) of the work on the given component was performed by the developer. In the configuration shown in FIG. 5, each familiarity feature variable 148 comprises a record that stores:
A component ID 150 referencing a given component.
A recency metric 152. Recency metric 152 can store the date and time that a given developer last worked on the given component.
A percentage metric 154. In one embodiment, processor 50 can compute percentage metric 154 to indicate a percentage of the number of the commits comprising the given component that were performed by the given developer (i.e., referenced by developer ID 140). In another embodiment processor 50 can compute the percentage metric is to analyze code differences 90 in order to compute a percentage of modified lines and/or modification events that can be attributed to the given developer.

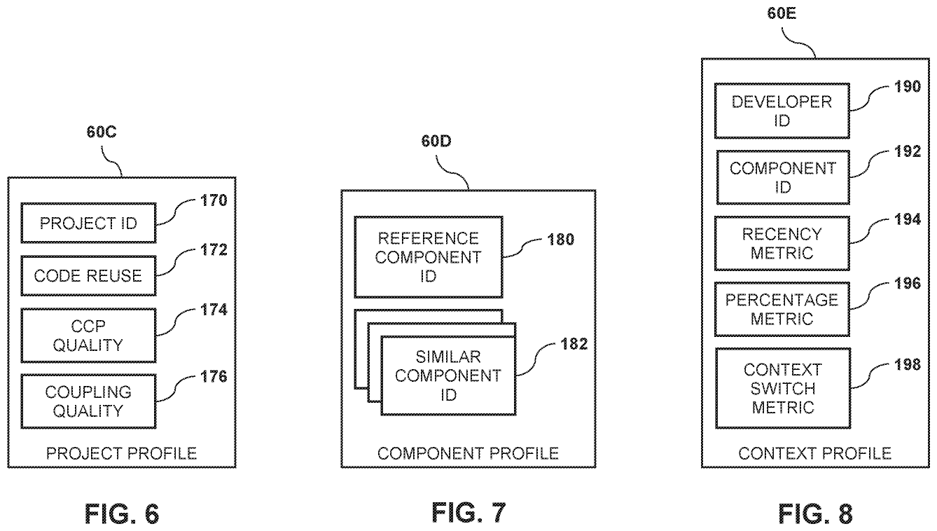

To generate project profile 60C, processor 50 can identify a set of unique project IDs 82 in completed task data records 56, and generate, based on information stored in ticket data records 54, completed task data records 56 and task profiles 60B, respective project profiles 60C for each of the unique project IDs. As shown in FIG. 6, each project profile 60C for a given project can store feature variables such as:
A project ID 170 indicating the given project. As described supra, each given project comprises multiple tasks. Therefore, each project ID 170 is similarly related to a corresponding multiple of task IDs 80.
A code reuse metric 172 indicating how much of the code in the given project comprises reused code. In some embodiments, processor 50 can use code analysis to identify import or other mechanisms of reuse. These identified mechanisms can serve as input to statistical analysis in order to evaluate the reuse level. For example, for a first given file 32 in a given project processor 50 can identify code reuse by identifying a second given file 32 used by the first given file, and then identifying if any other files 32 use the second additional file.
A project CCP quality metric 174 that can indicate a percentage of the task commits in the given project comprise bug fixes.
A project coupling quality metric 176. project coupling quality metric 176 can indicate an average number of components (e.g., files 32) that are used in the tasks belonging to the given project.

To generate component profile 60D, processor 50 can identify a set of unique components (e.g., files 32, projects referenced by respective project IDs 82 and systems represented by respective system IDs 84) in completed task data records 56, and generate, based on information stored in ticket data records 54, completed task data records 56 and task profiles 60B, respective component profiles 60D for each of the unique components. As shown in FIG. 7, the component profile for a given component can store feature variables such as:
A reference component ID 180 that references the given component.
One or more similar components 182. In some embodiments, processor 50 can use a similarity function to identify component(s) 182. For example, if reference component ID 180 comprises a given file 32, processor 50 can identify any components 182 using file similarity functions (e.g., close position in the file system, co-occurrence in changes), thereby identifying any files 32 that a given developer is relatively familiar with, even though the given developer never modified them.

To generate context profile 60E, processor 50 can first identify, in completed task data records 56, a set of unique developer IDs 82 referencing respective developers, and then identify, for each given developer, a set of components (e.g., files 32, projects referenced by respective project IDs 82 and systems represented by respective system IDs 84) that the given developer modified in the tasks (i.e., referenced by task IDs 80). Processor 50 can generate context profiles for each tuple comprising a given developer ID referencing a given developer, and a given component modified by the given developer. As shown in FIG. 8, the context profile for a given tuple may comprise:
A developer ID 190 comprising developer ID 82 (referencing a given developer) in a given completed task record 56.
A component ID 192 referencing a given component in the given completed task data record.
A recency metric 194 indicating a length of time since the given developer modified the given component. For example, recency metric may comprise a modification date or a number of days since the modification.
A percentage metric 196 indicating a percentage or ratio of modifications of the given component that were performed by the given developer. To compute percentage metric 196, processor can identify a first subset of completed task data records 56 comprising the given component (e.g., a given file 32 referenced by a given file ID 88), identify a subset or the completed task data records in the first subset comprising the developer ID, identify a number of the records in the first subset and a number of records in the second subset, and divide the second number by the first number.
A context switch metric 198 that can be used to identify any components in the task referenced by the given task record that match components in a given task most recently completed (i.e., prior to the task referenced by the given task record) by the given developer (i.e., the same developer). For example, context switch metric 198 may comprise a percentage of files 32 that the given developer used in the most recent previous task completed by the given developer.

In operation, processor 50 can generate and/or update profiles 60 upon the completion of each task 34. In addition to missing duration information, new tasks 34 (i.e., non-completed tasks are missing task-related information such as file IDs 88 and code differences 90. In embodiments described herein, task effort estimation model can use 26 can use information stored in profiles 60 (i.e., from all the completed tasks) to compute estimate 28, and to update the profiles with the missing task-related information.

### Effort Estimation Generation and Deployment

FIG. 9 is a flow diagram that schematically illustrates a method for generating task effort estimation model 26, in accordance with an embodiment of the present invention.

In step 200, processor 50 selects a set of completed software tasks. To perform step 200, processor 50 can identify and select a set of commits 34 from version control computer system 22.

In step 202, processor 50 retrieves the selected commits from version control computer system 22, and generates a corresponding set of completed task data records 56 using embodiments described supra.

In step 204, processor 50 extracts data from the retrieved commits, generates a set of feature variables for each of the commits, and stores the generated feature variables to the corresponding completed task data record. As described supra, processor 50 can extract, from the retrieved commits, feature variables such as task ID 80, project ID 82, system ID 84, developer ID 82, task type 84, file ID(s) 88, code difference 90 and parent commit(s) 92, and store the extracted feature variables to corresponding completed task data records 56.

Upon generating completed task data records 56 and populating the generated completed task data records with the extracted feature variables, processor 50 can generate a corresponding set of task profiles 60B, and in each given derived task record, store the corresponding task ID 80 to task ID 120, and store the corresponding task type 84 to task type 122.

In step 206, processor 50 can compute a task time duration for each given completed task data record 56 (i.e., an amount of time it took a given developer referenced by developer ID 82 in the given completed task data record to complete a given task referenced by task ID 80 in the corresponding completed task data record 34), and store the computed task time duration to task duration 124 in the corresponding derived task data record. Computing task durations 124 based on commit times in completed task data records 56 or the start and the end times in ticket data records 54 is described supra.

In step 208, processor 50 identifies and flags any given task profile 60B whose respective task ID 120 references:
a. A given task 34 that was a merged commit. Using embodiments described supra, processor 50 can determine whether or not the given task comprises a merged commit.
If processor 50 determines that the given task is a merged commit, then the processor can set the corresponding merged commit flag 130, thereby indicating that the given task is a merged commit.
b. A given task 34 that was submitted to the version control system by a “bot”. In one embodiment, processor 50 can determine that given task was submitted by a bot by extracting a username or an email address (i.e., for a given developer) from the commit message in the commit corresponding to the given task, and detecting the text string “bot” in the username. In another embodiment, processor 50 can determine that given task was submitted by a bot by analyzing completed task data records 56 for a given developer ID 82, and detecting (a) one or more commit times 86 at non-regular hours (e.g., between 11 PM and 5 AM) or (b) detecting that a number of the completed task data records within a specific time period exceeds a specified threshold (e.g., more than 20 completed task data records 56 in one 24 hour period).
If processor 50 determines that the given task was submitted to the version control system by a bot, then the processor can set the corresponding bot flag 128, thereby indicating that the given task was submitted to the version control system by a bot.
c. A given task 34 that was coded by a non-FTE developer. Using embodiments described supra, processor 50 can determine whether or not the given task was performed by a non-FTE developer. Processor 50 can identify a non-FTE developer by analyzing completed task data records 56 for a given developer ID 82, and detecting, in the completed task data records, commit times 86 that are sporadic (e.g., less than one per month) and that are during non-working hours (e.g., between 8 PM and 2 AM).
If processor 50 determines that the given task was performed by a non-FTE developer, then the processor can set the corresponding FTE flag 132, thereby indicating that the given task was performed by a non-FTE developer.

In step 210 if one or more of flags 128, 130 and 132 are to be used by processor 50 to filter ticket data records 54, completed task data records 56 and task profiles 60B, then in step 212, the processor can filter out any of the records that were flagged. For example:
If a bot filter is selected, then processor 50 filters out any task profiles 60B whose respective whose respective bot flag 128 is set, any completed task data records 56 whose respective task ID 80 matches any task ID 120 whose corresponding bot flag 128 is set, and any ticket data records 56 whose respective task ID 100 matches any task ID 120 whose corresponding bot flag 128 is set.
If a merged commit filter is selected, then processor 50 filters out any task profiles 60B whose respective merged commit flag 130 is set, any completed task data records 56 whose respective task ID 80 matches any task ID 120 whose corresponding merged commit flag 130 is set, and any ticket data records 56 whose respective task ID 100 matches any task ID 120 whose corresponding merged commit flag 130 is set.
If an FTE filter is selected, then processor 50 filters out any task profiles 60B whose respective FTE flag 132 is set, any completed task data records 56 whose respective task ID 80 matches any task ID 120 whose corresponding FTE flag 132 is set, and any ticket data records 56 whose respective task ID 100 matches any task ID 120 whose corresponding FTE flag 132 is set.

In embodiments of the present invention, any single one of the filters or any combination of the filters can be used by processor 50 so as to filter task profiles 60B in step 212.

Finally, in step 214, processor 50 can use the information in remaining ticket data records 54, completed task data records 56 and task profiles 60B to generate task effort estimation model 26, and the method ends. In embodiments of the present invention, classification engine 72 is configured to generate task effort estimation model 26 on the feature variables of profiles 60 (e.g., by weighting the feature variables) by using techniques such as logistic regressions and a neural networks to generate task effort estimation model 26 (e.g., by weighting the feature variables).

Returning to step 210, if none of flags 128, 130 and 132 are to be used by processor 50 to filter ticket data records 54, completed task data records 56 and task profiles 60B, then the method continues with step 214.

If none of the filters were selected in step 210, then the remaining records in step 214 comprise all ticket data records 54, completed task data records 56 and task profiles 60B. However, if any of the filters were selected in step 210, then the remaining records in step 214 comprise the filtered ticket data records 54, completed task data records 56 and task profiles 60B in step 212.

In embodiments described herein, task effort estimation model 26 comprises profiles 60A-60E. Generating profiles 60A-60E is described in the descriptions referencing FIGS. 4-8 hereinabove.

In some embodiments, effort estimation 26 may comprise a classical regression method. In these embodiments, processor 50 can build (i.e., from ticket data records 54, completed task data records 56 and task profiles 60B) a data set with the label to be predicted (i.e., task time estimate 28), feature variables used for the prediction, and fit task effort estimation model 26 to the data set, and use the task effort estimation model for the prediction.

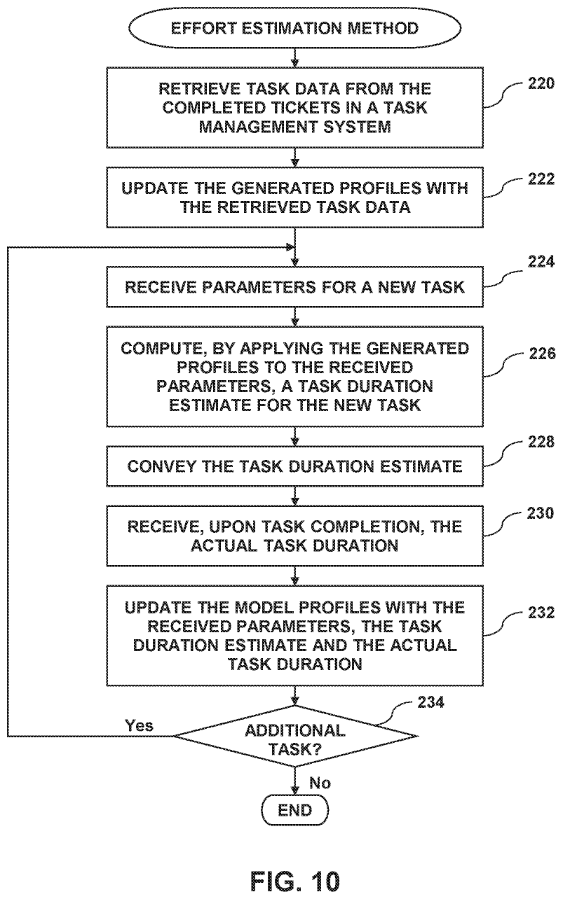

FIG. 10 is a flow diagram that schematically illustrates a method of using task effort estimation model 26 to provide task time estimates 28, in accordance with an embodiment of the present invention. In embodiments described in FIG. 9 hereinabove, processor 50 can generate task effort estimation model 26 based solely on data retrieved from task management system application 24 (i.e., profiles 60A-60E). In some embodiments as described supra, processor 50 can apply task effort estimation model 26 to the feature variables in profiles 60. In additional embodiments as described hereinbelow, processor 50 can enhance task estimation model 26 with information retrieved from a customer's ticket data records 54 when deploying the task effort estimation model to a customer's site.

In step 220, processor 50 identifies a set of ticket data records 54 referencing the tasks that have been completed, and retrieves data (i.e., task ID 100, task type 102, project ID 104, system ID 106, developer ID 108, company ID 110, developer role 110, developer group 112, start time 114 and end time 116) from the identified records. In some embodiments, processor 50 can perform step 220 by identifying ticket data records 54 whose end times 116 indicate that their corresponding tasks were completed.

In step 222, processor 50 updates profiles 60A-60E with the retrieved data from the identified ticket data records. In one embodiment, processor 50 may be able to compute more accurate feature variables from the ticket data records. For example, processor 50 can compute more accurate task durations 124 based on start times 114 and end times 116. In another embodiment, processor 50 can extract and/or generate feature variables (e.g., developer role 110 and developer group 112) from data solely stored in ticket data records 54 (i.e., information not stored or able to be computed from completed task data records 56).

In some embodiments, task effort estimation model 26 can be designed to use machine learning techniques that improve performance with larger sets of task commits 34. In some embodiments, processor 50 can also use transfer learning methodologies to enhance task effort estimation model 26. For example, the different models based on different use cases allow the use of transfer learning in order to improve the performance in the problematic use cases using models built on the easier use case. In principle, processor 50 can use all methods of transfer learning to enhance task effort estimation model 26. Examples of these transfer learning methods include, but are not limited to, domain adaptation and ensemble methods.

For example, task effort estimation model 26 might be used to provide task duration estimates for a small company, a new project or a developer starting to work in a new programming language (i.e., “small” datasets). This problem is common in machine learning and research areas like transfer learning and domain adaptation. In these situations, task effort estimation model 26 can use the large data sets from public GITHUB™ projects and large customers, and can use transfer learning techniques driven from these areas in order to improve the performance in areas where there is data lacking. The following are examples of how task effort estimation model 26 can use transfer learning:
In a first embodiment, task effort estimation model 26 can be used “as is” on the large data set in order to provide task time estimates for the lacking data areas.
In a second embodiment, processor 50 can build task effort estimation model 26 on the large data set and continue and tune it for a given small data set.
In a third embodiment, processor 50 can use task effort estimation model 26 that was generated from the large dataset as part of ensemble whose other models are trained on the small data set(s).
In a fourth embodiment, processor 50 can use task effort estimation model 26 as a labeling function, and use consistency as a way to aggregate. To accomplish this, processor 50 can use a framework for using semi-supervised or unsupervised learning to generate models when no labeled data is provided, as described in U.S. Patent Application 2019/0164086.
In a fifth embodiment, processor 50 can use labeling function discrepancy based active learning in order to identify the relevant samples and train task effort estimation model 26 on them, using embodiments described in U.S. Patent Application 2019/0164086.

In step 224, processor 50 receives task time estimation request 30 comprising new task ID 62 referencing a new task, a given developer ID 64 referencing a given developer, a given task type 66, an estimated task size 68 and one or more component IDs 70, and in step 226, in response to receiving the request, the processor applies effort estimation model 26 to (the feature variables in) task time information request 30 in order to compute task time estimate 28.

To compute task time estimate 28, task effort estimation model 26 can use any combination of the following feature variables in profiles 60A-60E to compute task time estimate 28:
In a first modeling embodiment, processor 50 can compute task time estimate 28 based on productivity metric 142 of the given developer's developer profile 60A.
In a second modeling embodiment, processor 50 can compute task time estimate 28 based on task CCP quality metric 144 of the given developer's developer profile 60A.
In a third modeling embodiment, processor 50 can compute task time estimate 28 based on coupling quality metric 146 of the given developer's developer profile 60A.
In a fourth modeling embodiment, processor 50 can compute task time estimate 28 based on one or more familiarity feature variables 148 of the given developer's developer profile 60A.
In a fifth modeling embodiment, processor 50 can compute task time estimate 28 based on any task profiles 60B whose respective task sizes 162 match estimated task size 68.
In a sixth modeling embodiment, processor 50 can compute task time estimate 28 based on any task profiles 60B whose respective task types 164 match given task type 66.
In a seventh modeling embodiment, the new task belongs to a project comprising existing source code modified by one or more tasks referenced by task IDs 80, and processor 50 can compute code reuse metric 172 indicating a reuse of the computer code, and compute task time estimate 28 based on the computed code reuse metric.
In an eighth modeling embodiment, the new task belongs to a project, and processor 50 can compute task time estimate 28 based on CCP quality 174 for the given project.
In a ninth modeling embodiment, the new task belongs to a project, and processor 50 can compute task time estimate 28 based on project coupling quality metric 176 for the given project.
In a tenth modeling embodiment, processor 50 can compute task time estimate 28 based on the identified one or more similar components referenced by one or more similar component IDs 184 for a given component in the new task referenced by reference component ID 182.
In an eleventh modeling embodiment, processor 50 can compute task time estimate 28 based on recency metric 194 for the given developer referenced by given developer ID 64 and the given component referenced by component ID 192.
In a twelfth eleventh modeling embodiment, processor 50 can compute task time estimate 28 based on percentage metric 196 for the given developer referenced by given developer ID 64 and the given component referenced by component ID 192.

In step 228, processor 50 reports the computed task time estimate. In one embodiment, processor 50 can present the computed task time estimate on a display (not shown). In another embodiment, processor 50 can store that computed task time estimate to a field (not shown) in the ticket data record corresponding to new task ID 62.

Upon receiving an indication that the given developer referenced by developer ID 64 completing the new task referenced by new task ID 62, in step 230, processor 50 can compute an actual task time duration it took the given developer to complete the new task. In one embodiment, processor 50 can detect that end time 116 in the ticket data record for the new task, and compute the actual task time duration by subtracting the start time from the end time. In another embodiment, processor 50 can receive an input specifying the actual task time duration for the new task.

In step 232 processor 50 updates profiles 60A-E with parameters 62-70, task time estimate 28 and actual task time duration. Updating effort estimation task effort estimation model 26 help processor 50 identify any developers that consistently underestimate or overestimate task sizes 126.

In step 234, if there is an additional task time estimation request 30, then the method continues with step 224. If there are no more task time estimation requests 30, then the method ends.

### APPENDIX 1—TASK EFFORT ESTIMATION MODEL DEVELOPMENT

### Related Work:

This Appendix provides some background to the development of task effort estimation model 26. As described supra, task effort estimation model 26 focuses on individual tasks, which are represented by commits 34. When analyzing commits 34, the inventors found that factors such as task size 126 and personal capabilities (e.g., productivity metrics 142), are very influential at both the project and the commit levels.

In some embodiments, task size 126 may be the most influential factor for computing task time estimate 28. This poses two difficulties in effort estimation. The first difficulty is that for a future task, the size of the tasks should be estimated as well, thereby reducing effort estimation to size estimation. The second difficulty is how to measure task size with a range of metrics for common lines of code (LOC), function points, entity relationship diagrams (ERD) properties, user story points and workdays, or aggregations of more basic metrics. In the field of effort estimation, there is a lack of consensus on the most reliable metrics to use to measure productivity. In fact, one survey (E. C. C. de Oliveira, D. Viana, M. Cristo, T. Conte, S. Hammoudi, M. Smialek, O. Camp, and J. Filipe. How have software engineering researchers been measuring software productivity?—a systematic mapping study. In ICEIS (2), pages 76-87, 2017) listed 91 productivity metrics suggested in 71 papers. In this survey, LOC was the most common metric.

The second most influential factor is personal/team capability. The goal of embodiments of the present invention is to predict a future task effort. One main factor that was identified is the personal average duration (i.e., productivity metrics 142) of a given developer. The average duration of a task is the inverse of the number of tasks in a time period. The number of commits 34 is correlated with self-rated productivity and team lead perception of productivity. Typically, the personal duration is more stable than the number of commits, making it a more reliable metric. Hence this factor is not only influential but is of interest on its own.

Many other influential factors in the project level are either not applicable in the commit level or influence as part of the project. Factors that were considered included product complexity, modern programming practices, required reliability, requirements volatility, timing constraints, software tools and more. Also considered were familiarity of the developer, equivalent to factors like application experience and language experience.

### Data Set Construction:

When developing task effort estimation model 26, one goal was to build a dataset that represents the way developers work. To reach this goal, the inventors used all the large active GITHUB™ projects (7,557 projects with 200+ commits in 2019). Some immediate threats are the validity of a labeling function, metric stability, and work done by bots. Due to the reasoning presented in these subsections the inventors decided to focus on commits done in the same day. The inventors analyzed approximately 20 million commits 34 from approximately 200 thousand developers (i.e., an amount of data that could not be analyzed manually). This enabled the inventors to cope with another problem in analysis of open source projects, specifically the common work of part time (i.e., non-FTE) developers. When analyzing one year of commits 34, a part time developer will typically look less productive. When focusing on the same date, this problem more or less disappears.

### Duration Labeling Function Validation:

In embodiments described herein, processor 50 can compute a given task duration 124 as the time since the previous commit of the same developer in the same repository (e.g., version control computer system 22). Note that this definition is just an estimation of the gross time, and even rougher estimation of the net time. A given developer might work on one repository, leave it for a few months and get back to it, having a large duration for the first commit after returning. Many developers work on many tasks in parallel so the work on a given task 34 might start way before the commit of the previous task.

In some embodiments, the difference between two adjunct commits 34 of the same developer may comprise a labeling function that can serve as a proxy to the actual duration 124. A labeling function is a weak classifier, typically comprising an estimation of the true label. Actual effort data is usually not available and when available (e.g., via time logging) their accuracy is problematic.

TABLE 1
Manual Labeling Results

| Duration | Duration Fit | Very Small |
|---|---|---|
| 1 minute | 0.9 | 0.9 |
| 1 minute to day | 1.0 | 0.44 |
| 1 day to week | 0.18 | 0.65 |
| Above week | 0.025 | 0.79 |

44% of the commit durations that were less than or equal to a single matched human labeling. When limiting the duration to eight hours, the ratio rises to 50%. 50 labeled commits for each group are presented in Table 1. Manual labeling for one-minute commits is the most certain: 25% were deletion, 22% were one-liners, 11% were a version bump and 8% looked as if they were generated automatically.

The other extreme is more than a week's duration. Unlike one-minute estimations, estimation of one week could be subjective yet only one commit 34 could be considered to require a week. Out of the others: 79% were very small, assured to take much less than a week.

As for labeled commits whose duration was between one day and one week, it seems that estimations somewhat improve. 18% estimation looked like more than a day. Out of those that seemed shorter, 65% seemed very small, compared to 79%. It can be assumed that the improvement is due to knowing that the developer worked about a week before.

When planning task effort estimation model 26, the inventors decided to focus on same date commits, which comprise approximately 75% of all commits. According to the manual labeling, their estimation is reliable. They have a considerable part of very small tasks whose effort is easy to estimate, yet it is lower than in the above one day groups.

### Commit Duration Stability:

Another way to validate the labeling function for task effort estimation model 26, is by examining its stability. If the metric measures some real-world behavior, it can be expected to receive similar results in different measurements and have a stable metric. This can be evaluated by investigating the metric stability comparing its value for the same developer in the same project in two adjacent years.

When designing task effort estimation model 26, a few metrics were used in order to compare their relative stability. The metrics comprised the number of commits 34, an average of durations 124, an average duration 124 of tasks done in the same date, average durations 124 capped by a week and two weeks. Note that while one can have the same number of commits 34 in two years, the respective averages of their (i.e., the commits) durations 124 may be very different, for example when comparing uniformly distributed commits 34 to the commits in one dense sprint.

The capped duration of commits 34 is bounded, hence has an advantage in stability.

Table 2 presents the Pearson correlation of the metrics on the same developer and repository in adjunct years. Each row represents the minimal number of the commits so as to classify a given individual as a developer, in order to reduce noise. The same day metric is significantly more stable, given any number of minimum commits 34. The lower the capping value, the better the stability. The stability of the capped one and two week metrics is similar and better than that of the commits.

This is another reason to focus on the stable same date metric.

TABLE 2
Pearson Correlation of Duration Metrics

| Min. | | | Same | 1 Week | 2 Week |
|---|---|---|---|---|---|
| Commits | Commits | Duration | Day | Cap | Cap |
| 12 | 0.08 | 0.08 | 0.27 | 0.11 | 0.11 |
| 50 | 0.12 | 0.07 | 0.45 | 0.17 | 0.17 |
| 100 | 0.13 | 0.11 | 0.45 | 0.24 | 0.23 |
| 150 | 0.13 | 0.13 | 0.45 | 0.28 | 0.27 |
| 200 | 0.11 | 0.12 | 0.44 | 0.29 | 0.25 |

### Bot Identification:

Bots tend to work periodically on specific tasks in a manner that does not resemble human work. More than that, since bots tend to submit many commits 34, their work will receive high weight.

In principle, GITHUB™ enables marking bots in the user type to enable their identification. However, this property use is not very common and many bots (e.g., they have “bot” in their name) don't have this property properly set.

Instead, labeling function was used in order to mark bots. Given a good enough estimation the labeling function can be used in order to characterize bot behavior.

Labeling functions are typically heuristics that can be computed. In some embodiments, task effort estimation model 26 may comprise a labeling function that classifies a given developer ID 82 as a bot if the given developer ID was found in more than 1,000 task commits 34 commits during a consecutive 12 month period. While 99.8% of the observed developers fell below this threshold, developers having certain behavior can reach it (e.g., by having many small commits, no code review process, more than a full-time work).

This labeling function was validated by showing that it separates the developers into groups of very distinct behavior in many aspects. When designing the bot identification routine(s) in task effort estimation model 26, processor 50 analyzed the activity of single developers in single projects during 2019. Out of all these developers, 87% performed commits 34 during 10 or fewer distinct hours, compared to 2% of the bots.

Similar results are obtained for working five distinct days of week. Only 6% of the bots never committed on Saturday, compared to 78% of the developers. 88% of the developers worked at most five days every week 260=52*5 days, compared to 11% of the bots.

89% of the developers had a day of week entropy of at most log₂(5)=2.32, expected when they are similarly working five days a week, compared to 7% of the bots. Entropy of at most one, expected to work on weekends, is typical to 66% of the developers and only 1% of the bots. While checking a sample manually, the inventors noticed that they are indeed bots used for automatic activities.

### Merge Commits:

Merge commits are a technical artifact of the work in the GIT™ tool in GITHUB™. Merged commits typically do not represent the base development task but the merge (inclusion) of the work in one branch to another. One can identify merge commits as those that have multiple parents (e.g., the task branch and the main branch).

Merge commits were observed to be 14% of the commits. The duration of 24% of the observed merge commits was one minute or less, 38% of the observed merged commits took at most 10 minutes, and the longest observed merge commits took approximately 1.5 hours. Since (a) they do not represent an independent task and (b) their duration characteristics are very different, they were excluded from the analysis. Hence, they can also be ignored when considering the duration from a current commit to the previous one.

### Commit Duration:

The commits in the following section refer to the set of commits 34 that were used to build task effort estimation model 26. The average duration of same date commits was 83 minutes, slightly less than 1.5 hours. 12% of the commits were one minute or less. 29% of the commits had durations of 10 minutes or less, 45% of the commits had durations of one hour or less, and 75% of the commits had durations of one day or less. This means that a large group of the commits do not involve holidays, etc. and rather reliable.

### Developer:

The importance of the developer in the obtained performance is well known and is the root of the “ten times programmer” hypothesis (as described in [a] B. W. Boehm, J. R. Brown, and M. Lipow. Quantitative evaluation of software quality. In Proceedings of the 2Nd International Conference on Software Engineering, ICSE '76, pages 592-605, Los Alamitos, Calif., USA, 1976. IEEE Computer Society Press, [b] L. Prechelt. The mythical 10× programmer. In Rethinking Productivity in Software Engineering, pages 3-11. Springer, 2019, [c] H. Sackman, W. J. Erikson, and E. E. Grant. Exploratory experimental studies comparing online and offline programming performance. Commun. ACM, 11(1):3-11, January 1968). When analyzing the personal same date duration average distribution (with additional condition of at least 20 same date commits), the average durations 124 were 36 minutes for a developer in the top 10%, 88 minutes for the median and 193 minutes for the slowest 10%. Hence the top 10% are about 5 times faster than the slowest and 2.5 times faster than the median.

Though, not ten times faster, the gaps are considerable enough to make task duration estimation inaccurate without knowing who will be assigned to it.

By simply investing more time in each task, the quality can be improved. Hence it is interesting to observe the relation by the quality and duration per developer. The quality of a given developer's work using the CCP and the corrective commits probability are measured on files written by (only) the given developer. The Pearson correlation between the CCP and same day duration is 0.14, i.e., positive but not strong. It was observed that the lower deciles, while being of higher quality, also had lower duration, while the upper deciles have higher duration. Hence, it seems that the common relation is not a trade-off. Skill or motivation might contribute to both quality and productivity, leading to the results observed. A support to the influence of the motivation is that the working days average duration is 61 higher than that of weekend.

Co-change analysis was used in order to see how quality and productivity change over time. The CCP and duration of the same project in two adjacent years were compared to see how they co-changed. Given an improvement of 10 percentage points in CCP, the probability of improving the same day duration in 10 minutes was 38%, a lift of 6%.

Another question of interest is the influence of the project on the developer. When a productive project is identified, it can be useful (and interesting) to know if that the developers are simply more productive, or whether the project itself contributes to the productivity of the project. This can be answered by using a twin experience, i.e., comparing the productivity of the same developer acting in two different projects. Given that a first project is more productive than a second project, in 73% of the cases a given developer will be more productive in the first project than in the second project, a lift of 45%. If a change of at least 10 minutes is required, the probability is 71% with a lift of 57%.

### Task Size:

The most important factor in task estimation is typically the size of the task. This is quite intuitive in the sense that you cannot estimate a task well without knowing if it should be small or large.

When analyzing completed tasks, the duration distribution can be divided into deciles of different duration, representing size. When working on future tasks, task effort estimation model 26 can be provided with a given decile as a size parameter, thereby mimicking a human expert.

Many times when a task is not completed in the estimated time, it is not clear if the estimation was too low or the execution too slow. By separating the size as a specific parameter, one can analyze the size on its own, providing insights like: “Your size estimations average is systematically 20% lower than the expected”, solving the source of the mismatch and providing an easy way to improve estimations.

When analyzing the commits to build task effort estimation model 26, the duration deciles almost perfectly doubled themselves from one decile to the next. That means that if one estimates a task to be in the 60% and it is in the 70%, its duration will be double, explaining why effort estimation is hard.

It is also important to note that 30% of the same date commits took three minutes or less. Even if such task actual time is doubled, its impact on deadlines will typically not be more devastating than a coffee break, so they are probably not too interesting.

### Task Type:

The inventors used the classic taxonomy of Lientz et al. for commits (B. P. Lientz, E. B. Swanson, and G. E. Tompkins. Characteristics of application software maintenance. Commun. ACM, 21(6):466-471, June 1978) and identify them using the linguistic models provided by Amit and Feitelson (I. Amit and D. G. Feitelson. Which refactoring reduces bug rate? In Proceedings of the Fifteenth International Conference on Predictive Models and Data Analytics in Software Engineering, PROMISE'19, pages 12-15, New York, N.Y., USA, 2019. ACM).

When analyzing the commits to build task effort estimation model 26, the average duration of a same date commit was 83 minutes. Corrective commits, i.e., bug fixes had an average of 100 minutes, 20% higher than the average duration of the same date commits. Adaptive commits, adding new feature variables, had an average of 82 minutes, 1% lower the average duration of a same date commit. Perfective commits (refactor commits or documentation improvements), had an average of 88 minutes (a 6% increase) for refactors and 85 minutes (a 2% increase) for documentation improvements.

However, corrective commits tend to involve less files 32. When considering single file commits, the duration of the corrective commits was 26% higher than that of adaptive commits.

### Files Number:

When analyzing the commits to build task effort estimation model 26, the number of files 32 in the commits were used in order to estimate the sizes of the commits. The average number of files 32 in a given commit 34 was used as a coupling metric, and was shown to fit developer perception of coupling and presence of bugs. The number of files 32 was used both as a size metric and as a coupling metric.

The analysis showed that the task duration increases as the number of the files in the tasks increased from one to five. Commits 34 comprising between nine and fifty files had similar durations. The commits comprising more than fifty files 32 had shorter durations, possible due to automatic modification.

### Use of Tests:

The use of test files could double the number of the files compared to the number of the functional files. Therefore, the files that were identified as test files were excluded from the analysis.

Test files can be identified by looking for the string “test” in the file path. The positive rate of “test” pattern was 15% of the files contained in the commits. In the analysis, 50 files were labeled and only one of the labels was wrong (a non-robust estimation of 97.5% accuracy). Another 20 hits of the labeling function were labeled as well. While only 35% of the hits were test files, another 60% were related files (e.g., test data or make file), leading to a precision of 95%. The only labeled false positive had the pattern “test” as part of the string “cuttest”. Note that Berger et al. reported 100% precision of the same pattern, based on 100 samples (E. D. Berger, C. Hollenbeck, P. Maj, O. Vitek, and J. Vitek. On the impact of programming languages on code quality. CoRR, abs/1901.10220, 2019).

The use of tests has a significant influence on duration too. The most straightforward way to evaluate use of tests is to measure the test file ratio. However, this distribution is distorted since a certain ratio implies a certain number of commit files. For example, while 0.5 comes from an even number of the commits, 0.33 must divide in three and so on for every prime number. While 0.33 might be also due to six, nine etc., the probability of commit size of three is higher so test ratio and commit size were mixed.

In order to cope with this situation, commits of size 4 were considered. The average duration of a given commit 34 without any test file is 101 minutes. A given commit 34 comprising either one or two test files took 120 minutes, an 18% increase. A given commit 34 comprising four files 32 and also having more test files than functional code files (i.e., a less common situation) took 114 minutes for three test files and 84 minutes for the commits comprising test files only.

### File Properties:

When performing the analysis to build task effort estimation model 26, the influence of the properties of the files involved in the commit were analyzed. When analyzing the relation between the CCP of a given file 32 and the duration of the commits involving the given file, the duration in the last decile was 50% higher than the duration in the first decile, and the Pearson correlation between the deciles was 0.11.

An analysis of deciles of the commit durations indicated that durations for the deciles increased with file coupling until the last decile of more than 200 files, which typically (i.e., the last decile) does not represent a regular manual work. The duration in the ninth decile was 45% more than the first decile. The Pearson correlation is negative, −0.04, probably due to the behavior in the last decile.

The analysis of the durations of the commits for files 32 also indicated a low Pearson correlation of 0.005, yet the median duration in the last decile is 24% higher than in the first.

Time from Previous Update:

Boehm showed in 1976 that the later an error appears in the development process, the more it costs (Boehm. Software engineering. IEEE Transactions on Computers, C-25(12):1226-1241, 1976). Since then, it became generally accepted that fixing bugs costs more the later they are found, and that maintenance is costlier than initial development. However, an attempt to validate the claim in today's software development by Menzies at al. didn't find any supporting empirical evidence (T. Menzies, W. Nichols, F. Shull, and L. Layman. Are delayed issues harder to resolve? revisiting cost-to-fix of defects throughout the lifecycle. Empirical Software Engineering, 22(4):1903-1935, November 2016). While related to these prior studies, the analysis performed by the inventors did not focus on the entire “cost” (e.g., damage from the faulty software, cost of redeployment) but only the developer's effort to fix the error. Additionally, the analysis observed commits 32 in a phase of at least coding, some time operations, and many projects nowadays simply do not fit the Waterfall model (W. W. Royce. Managing the development of large software systems: Concepts and techniques. In Proceedings of the 9th International Conference on Software Engineering, ICSE '87, page 328-338, Washington, D.C., USA, 1987. IEEE Computer Society Press) phases.

Kim and Whithead reported that the median time to fix a bug is about 200 days (S. Kim and E. J. Whitehead, Jr. How long did it take to fix bugs? In Proceedings of the 2006 International Workshop on Mining Software Repositories, MSR '06, pages 173-174, New York, N.Y., USA, 2006. ACM). In order to compute the duration for a bug fix, the bug inducing the commit should be identified, for example by using the Sliwerski-Zimmermann-Zeller (SZZ) algorithm (J. 'Sliwerski, T. Zimmermann, and A. Zeller. When do changes induce fixes? SIGSOFT Softw. Eng. Notes, 30(4):1-5, May 2005), which requires access to the source code in each commit. In the analysis to develop task effort estimation model 26, the GitHub “BigQuery” schema was used so as not to have such access. Instead, the last time that a given file 32 was touched before a commit was used, which is a lower bound of the time to fix a bug. When analyzing the commits for fixed bugs, (a) in 24% of the commits, the file was updated at most one day ago, (a) in 41% of the commits, the file was updated at most week ago, (c) the median of the number of days since the file was last updated was 15 days, and (a) in 59% of the commits, the file was updated at most 30 days ago. Assuming an exponential model, time to miss only 1% of the current bugs was

15*log₂(100)=15*6.64

In the analysis, the average time since a bug correction to the previous time the involved file was previously modified was 131 days, i.e., greater than 4 months.

In order to validate the “Time from Previous Update” metric, the influence of behaviors that should change the time needed to identify bugs was observed. The average CCP of a project with hardly any tests (i.e., (less than 1% test files in commits)) is 0.15 compared to 0.24 in the rest, indicating that the inefficiency in bug-detection influences significantly the observed quality.

Repositories (e.g., i.e., projects tracked in version control system 22) with code reuse were found to have commits 34 that found bugs after 76 days, as compared to 77 day for repositories without code reuse. The comparison of Amit and Feitelson (I. Amit and D. G. Feitelson, “The Corrective Commit Probability Code Quality Metric” cited supra) for same organization projects differing in popularity, used to support Linus's law (E. S. Raymond. The cathedral and the bazaar. FirstMonday, 3(3), March 1998). Extremely popular projects were defined to be those in the top 5% s, with at least 7,481 stars. Extremely popular projects of ‘Google’, ‘Apache’, ‘Tensorflow’, ‘Facebook’, ‘Angular’, and ‘Kubernetes’ were found to have identified bugs in 51 days on average, compared to 78 days (53% higher) for “less popular” projects. Comparing per organization the result holds for all but ‘Angular’ and ‘Kubernetes’, each with only 3 extremely popular projects. Project age on one hand upper bounds time to find a bug and on the other correlated with popularity. Age explains part of the behavior, but the analysis is based on a single project in some cases.

### Code Familiarity:

Intuitively, a developer that is familiar with the code in a given file 32 is expected to need less time to modify the code. In the analysis, this was found to be generally true, but with two deviations in “no familiarity” and in a one week period. The commits in the files for which the developer has no familiarity were performed faster than the commits in the files touched by the developer about a month ago. However, the ratio of short tasks, less than 10 minutes is higher in no familiarity tasks, indicating that people tend to work on simpler tasks in areas that they are not familiar with.

“Tasks on one or more files 32 touched by a given developer a week ago take more than those touched a single day or a month ago, hinting that the reason is not how well the given developer “remembers” those one or more files 32.” One possible reason is the “mess up” hypothesis, claiming that if a developer returns to a file in a week it is due to a problem that was encountered. Indeed, the CCP of the tasks returning in a week is 0.24, 36% higher than tasks in which the given developer returns to the same file 32 within one day (which can represent both a mess up or a continuing work).

Results in the same spirit were reported by Wang et al. (C. Wang, Y. Li, L. Chen, W. Huang, Y. Zhou, and B. Xu. Examining the effects of developer familiarity on bug fixing. Journal of Systems and Software, page 110667, 2020) that investigated the familiarity of the developer with the fixed code. Familiarity was measured in the line of code resolution and effort was based on the difference between issue start and end times. According to Wang, “Compared to the high-familiarity bug fixing, the average fixing effort of the low-familiarity bug fixing is 1.599 times higher”. When long tasks duration were compared with no familiarity to those with on day familiarity a 25% additional duration was observed.

When analyzing familiarity as a ratio of commits done by the developer on the file, it was observed that duration peaks in the ratios indicating no and medium familiarities. The long duration in no familiarity is expected, and emphasized by the lower ratio of short tasks compared to “up to 0.1”. The peak in the middle seems to be a tradeoff between the familiarity with the file and task complexity.

Another question of interest is the context in which the task was done. The files in the current commit 34 were compared to the files in the previous commit. Looking again in commits of size four, the duration of zero to three matching files was 104-107 minutes. However, when the matching is full (i.e., all four files, the duration was 87 minutes, 83% lower than the rest.

Developer familiarity with the project is considered to be influential on productivity. When looking at the same date duration, the average for developers with at most 10 commits in the project is 94 minutes, compared to 93 minutes with above 200 commits (achievable in about one year's work). While new developers in a project might devote more time to training and have easier tasks assigned to them, they may perform their task as developers familiar with the project.”

### Project:

Twin experiments that compared the productivity of the same developer in different projects showed that the project is influential (I. Amit and D. G. Feitelson, “The Corrective Commit Probability Code Quality Metric” cited supra). While one common belief is that larger projects may have longer task durations, the reality is more complex. The average same duration in young projects, up to two years, is 17% higher than the rest.

Metrics for task size 126 were also investigated, specifically the number of commits 34, the number of developers and the number of files 32. The number of commits 34 and their respective durations had a Pearson correlation of −0.02, the number of developers had a Pearson correlation of 0.03, and the number of files 32 had a Pearson correlation of −0.005, all very small. CCP, this time in the repository level, had a Pearson correlation of 0.11 with the duration.

In addition to projects, organizations (i.e., companies) were also found to be influential on the duration 124. In the analysis, company employees were identified by matching the developer email domain with that of the company. The results of the organization analysis are presented in Table 3 hereinbelow, which lists, for each organization, the number of identified developers, and the average duration of same-date commits. Since all these companies are proud of both their technical personal and high standards, it is possible that these differences are due to organizational culture, methods and applications.

The inventors conducted another “twins experiment” and compared the average duration of a developer when working for the employer vs. when volunteering. In 81% of the cases the developer had lower duration when working for the employer. This result has additional value since it doesn't match Parkinson's law (C. N. Parkinson and R. C. Osborn. Parkinson's law, and other studies in administration, volume 24. Houghton Mifflin Boston, 1957). Some managers are not interested in accurate estimation but a lowering one, suspecting that additional allocated time will increase the work duration. Since the developer has no time constraints when volunteering and yet works faster for the employer, the threat is apparently not big in this context.

TABLE 3
Duration by Company

| | | Same Date |
|---|---|---|
| Domain | Developers | Duration Avg. |
| apple.com | 79 | 173 |
| google.com | 1177 | 154 |
| fb.com | 248 | 145 |
| microsoft.com | 358 | 139 |
| us.ibm.com | 71 | 139 |
| oracle.com | 72 | 103 |
| sap.com | 94 | 102 |
| jetbrains.com | 178 | 92 |
| googlemai.com | 158 | 90 |
| redhat.com | 640 | 85 |
| intel.com | 204 | 81 |
| digital.cabinet-office.gov.uk | 114 | 54 |
| arm.com | 58 | 53 |

### Code Reuse

Code reuse is considered to be an efficient method to improve productivity. The simplest justification to that is that a reusing code is more efficient than rewriting code. Other than that, code reuse helps to improve quality. Refactors that involve reuse are effective in reducing future bug rates. Each reuse case helps to differentiate between the code needed to implement the functionality and the code encapsulated in the reused component, advocated by the single responsibility principle (R. C. Martin. Agile software development: principles, patterns, and practices. Prentice Hall, 2002). Each reuse case is another pair of “eyeballs” that uses and takes a look in the reused component, and by Linus's law (referenced supra) increases bug detection efficiency. If the same developer works on both the reusing and the reused component, a reuse case is an opportunity to refactor and extend and further improve the reused component.

Reuse can be measured by extracting cases of one component in a repository is using another one. The method of using a component is language specific. In one embodiment, Java projects using “import” for code reuse can be used for reuse analysis. In this embodiment, only inter-repository reuse needs to be considered, and widely reused projects like “JUnit” or “Swing” are out of scope.

Note that “import” is the language mechanism for a file reuse. However, the metrics can be further validated by matching them with developers' perception of reuse by the method presented by Amit and Feitleson (I. Amit and D. G. Feitelson, “The Corrective Commit Probability Code Quality Metric” cited supa). Commit messages 48 were also analyzed for referring to reusability. In repositories that had at least 10 commit messages referring to reuse, the number of links was 75% higher, the imported files were 38% higher, and the number of importing files was 78% higher.

The impact of reuse is moderate on the project level and high on the file level. The same date average duration in a reusing project, with at least 100 reuse links, is 107 minutes compared to 118 minutes—10% lower. The CCP in the reusing projects 0.26 compared to 0.23, 13% higher bug fixing ratio. An increase in CCP is commonly due to the presence of more bugs but might also be due higher bug detection efficiency which can reach 30% in popular projects (I. Amit and D. G. Feitelson, “The Corrective Commit Probability Code Quality Metric” cited supra).

However, as stated supra, bugs are typically identified only 1% faster in projects with reuse. In the file resolution, reused file is CCP of 0.2 compared to 0.23 and average of last touch time for bugs of 32 days compared to 56, only 57%. A possible reason for the moderate difference of duration in the project level, is that the average duration in files that are reused is 125 minutes, 19% higher than the general case. Hence, coding for reuse requires an increased effort which is paid back in the reuse events.

For this analysis the GitHub schema in BigQuery was used, which contains only the files HEAD version (current version). Consequently, the relation by reuse, quality and productivity using co-change analysis could not be investigated any further.

### Model Evaluation

There are two common metrics for effort estimation. Pred(25), the ratio of cases whose estimation is in the range of 25% from the actual is a common metric for effort estimation. According to Wen et al. (J. Wen, S. Li, Z. Lin, Y. Hu, and C. Huang. Systematic literature review of machine learning based software development task effort estimation models. Information and Software Technology, 54(1):41-59, 2012), a task effort estimation model is widely considered acceptable if Mean Magnitude of Relative Error (MMRE)≤25% and Pred (25)≤75%”. The systematic literature review of Wen at al. (referenced supra) on project effort estimation report on best results of pred (25)=94% (mean 72%) and MMRE=9% (mean 34%).

Weiss at al. (C. Weiss, R. Premraj, T. Zimmermann, and A. Zeller. How long will it take to fix this bug? In Fourth International Workshop on Mining Software Repositories (MSR'07:ICSE Workshops 2007), pages 1-1, 2007) investigated how long bug fix will take by using time-logging in JBoss. Using KNN with text similarity as a distance function, they reached PRED(50) of 30%.

In some instances, the most significant factor influencing tasks' duration is this size (B. W. Boehm. Software Engineering Economics. Prentice-Hall, 1981). In algorithmic prediction setting, this may present a problem since a human expert that will give us such estimation is typically not available. As an alternative, the duration of the completed task was used, and the relevant duration group computed in order to simulate the human expert that is capable to predict a future task duration group and provide it as a size estimation. A data set of same date commits whose duration is at least one minute was used.

The influence of many of the factors on their own was used in the analysis. However, when treating the factor as a group, a useful factor might not contribute due to redundancy with other factors. In order to investigate the contribution of a factor in a set ablation was used to analyze removal of the factor and comparing the results with and without it. The results are presented in Table 4.

TABLE 4
Effort Estimation Performance

| Model | Pred | MMRE |
|---|---|---|
| Thirds Alone | 21.6% | 93.9% |
| Deciles Alone | 70.3% | 20.7% |
| Size ablation | 43.7% | 502.6% |
| Deciles | 87.9% | 9.9% |
| Deciles - Developer ablation | 87.9% | 10.0% |
| Deciles - Repository ablation | 87.9% | 10.0% |
| Deciles - Familiarty ablation | 87.9% | 10.0% |
| Deciles - Type ablation | 87.9% | 10.0% |
| Deciles - Tasks' files ablation | 86.0% | 11.2% |
| Deciles - File properties ablation | 86.0% | 11.3% |
| Deciles - Last update ablation | 80.2% | 15.7% |
| Java Projects, Deciles | 86.6% | 10.9% |
| Java Projects, Deciles, reuse ablation | 86.6% | 10.9% |

### Threats to Validity

The analysis analyzed factors so as to build a model with respect to a labeling function. The main threat is how well the labeling function mimics the real effort. In order to reduce this threat, cases were manually labeled. Reproducing results that appear in the literature shows that the behavior of the labeling function is similar to the behavior presented in prior work. The ability to predict the labeling function shows that it obeys a rule governed by the provided feature variables.

The analysis focused on tasks whose duration was at most a day, since their duration estimation was more reliable. This leads to two threats. First, does the model and insight extrapolate into longer duration? Second, does the trimming miss the important, longer tasks? By using factors that are supported by prior work, the inventors have more confidence in the extrapolation. The labeling of long tasks (above a week) indicated that real long tasks are rare. The habit of decomposing long tasks into sub tasks, a common procedure, make this threat irrelevant to the practitioner.

### CONCLUSION

The analysis used in embodiments of the present invention generated a new resolution for software effort estimation, and constructed a large data set in order to investigate the new resolution. The predictions of the model described herein are better than that achieved in close tasks, and are above the acceptable level.

Additionally, the analysis:
Showed that “10 times programmers” is an overestimation, but “2 times” programmers are very common.
Showed that tests increase task duration in 18% and in return reduce average time to find bugs in 25%.
Provided evidence to Linus' law (referenced supra), based on time to identify a bug.
Showed that the value of code familiarity in a steady context.
Showed how coupling and low quality increase development duration, supporting the “Quality is Free” hypothesis (P. Crosby. Quality Is Free: The Art of Making Quality Certain. McGrawHill, 1979).
Showed that code reuse helps to reduce development duration and increase quality.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
selecting, from a source code management system, a set of software tasks completed by a plurality of developers, each of the tasks comprising a single unit of work in a software project;
retrieving, from the source code management system, information for each given selected completed software task;
building, by a processor, a task effort estimation model which correlates between task features and corresponding task durations, based on the retrieved information about the selected set of software tasks, wherein the task features include components to be modified in carrying out the task;
receiving a time estimation request for a new software task, the time estimation request comprising an identifier for a given developer, one or more components to be modified in performing the task, and one or more additional parameters;
applying, by a processor, the built task effort estimation model to the received request so as to compute a time estimate for the new software task, responsive to the given developer, the one or more components to be modified in performing the task and the one or more additional parameters; and
reporting the computed time estimate in response to the request.

2. The method according to claim 1, wherein the one or more additional parameters comprise a task type, which comprises a value from a group including: a new system feature for the software project, a refactor for the software project, and a software patch to fix a bug for the software project.

3. The method according to claim 1, wherein the task type comprises a refactor for the software project.

4. The method according to claim 1, wherein the task type comprises a software patch to fix a bug for the software project.

5. The method according to claim 1, wherein the source code management system comprises a version control system, and wherein the software tasks completed by a plurality of developers comprise commits.

6. The method according to claim 5, and comprising retrieving, from a task management system, additional information for a plurality of the software tasks, and wherein building the task effort estimation model comprises modeling the retrieved additional information.

7. The method according to claim 1, wherein the source code management system comprises a task management system.

8. The method according to claim 1, wherein selecting the set of software tasks from which the task effort estimation model is built, comprises identifying one or more completed software tasks that were stored to the source code management system by a bot, and excluding the identified one or more completed software tasks from the modeling of the retrieved information.

9. The method according to claim 1, wherein selecting the set of software tasks from which the task effort estimation model is built, comprises identifying one or more completed software tasks that comprise merged completed software tasks, and excluding the identified one or more completed software tasks from the modeling of the retrieved information.

10. The method according to claim 1, and comprising classifying one or more of the developers as not full-time employees (FTEs), and wherein selecting the set of software tasks from which the task effort estimation model is built, comprises identifying one or more of the completed software tasks that were submitted by the one or more developers classified as a non-FTE, and excluding the identified one or more completed software tasks from the modeling of the retrieved information.

11. The method according to claim 1, wherein building the task effort estimation model comprises computing, for the given developer, a task completion duration for the tasks completed by the given developer, and computing one or more productivity metrics based on the computed task completion durations, and wherein the time estimate is based on the one or more computed productivity metrics.

12. The method according to claim 11, wherein computing a given task completion duration for a given task comprises identifying a most recent previous software task completed by the given developer, and computing an amount of time between the given task and the identified most recent task.

13. The method according to claim 1, building the task effort estimation model comprises determining a corrective commit probability (CCP) quality metric for a given developer, and wherein the time estimate is based on the CCP metric.

14. The method according to claim 1, wherein building the task effort estimation model comprises computing an average number of components in the tasks completed by the developer, and wherein the time estimate is based on the computed average.

15. The method according to claim 1, wherein applying the built task effort estimation model to the received request comprises identifying for each given component of the one or more components identified in the request, a time when a most recent task comprising the given component was completed by the developer, and wherein the time estimate is based on the identified time.

16. The method according to claim 1, wherein applying the built task effort estimation model to the received request comprises identifying for each given component of the one or more components identified in the request, a number of the tasks comprising the given component that were completed by the developer, and wherein the time estimate is based on the identified number of the tasks.

17. The method according to claim 1, wherein the one or more additional parameters in the received time estimation request comprise an estimated task size, and wherein building the task effort estimation model comprises computing respective task completion durations and corresponding task sizes for the completed tasks, and wherein the time estimate is based on the estimated task size, the computed task completion durations and the corresponding task sizes.

18. The method according to claim 1, wherein the one or more additional parameters in the received time estimation request comprise an assigned task type, and wherein building the task effort estimation model comprises computing respective task completion durations and corresponding task types for the completed tasks, and wherein the time estimate is based on the assigned task type, the computed task completion durations and the corresponding task types.

19. The method according to claim 1, wherein the new software task belongs to a project comprising one or more of the completed tasks, and wherein building the task effort estimation model comprises computing a code reuse metric for the one or more completed tasks, and wherein the time estimate is based on the computed code reuse metric.

20. The method according to claim 1, wherein the new software task belongs to a project comprising a subset of the completed tasks, and wherein building the task effort estimation model comprises identifying, a number of the tasks in the subset that comprise bug fixes, and wherein the time estimate is based on the identified number of the tasks.

21. The method according to claim 1, wherein the new software task belongs to a project comprising a subset of the completed tasks, and wherein building the task effort estimation model comprises identifying, in the subset, a number of components, and wherein the time estimate is based on the identified number of the components.

22. The method according to claim 1, wherein applying the built task effort estimation model to the received request comprises identifying one or more additional components similar to the one or more components to be modified in performing the task, and wherein the time estimate is based on the identified one or more additional components.

23. A computer system, comprising:
a memory configured to store a source code management system comprising multiple software tasks completed by a plurality of developers, each of the tasks comprising a single unit of work in a software project; and
one or more processors configured:
to select a set of the completed software tasks,
to retrieve, from the source code management system, information for each given selected completed software task,
to build a task effort estimation model which correlates between task features and corresponding task durations, based on the retrieved information about the selected set of software tasks, wherein the task features include components to be modified in carrying out the task;
to receive a time estimation request for a new software task, the time estimation request comprising an identifier for a given developer, one or more components to be modified in performing the task, and one or more additional parameters,
to apply the built task effort estimation model to the received request so as to compute a time estimate for the new software task, responsive to the given developer, the one or more components to be modified in performing the task and the one or more additional parameters, and
to report the computed time estimate in response to the request.

24. A computer software product for protecting a computing system, the product comprising a non-transitory computer-readable medium, in which program instructions are stored, which instructions, when read by a computer, cause the computer:
to select, from a source code management system, a set of software tasks completed by a plurality of developers, each of the tasks comprising a single unit of work in a software project;
to retrieve, from the source code management system, information for each given selected completed software task;
to build a task effort estimation model which correlates between task features and corresponding task durations, based on the retrieved information about the selected set of software tasks, wherein the task features include components to be modified in carrying out the task;
to receive a time estimation request for a new software task, the time estimation request comprising an identifier for a given developer, one or more components to be modified in performing the task, and one or more additional parameters;
to apply the built task effort estimation model to the received request so as to compute a time estimate for the new software task, responsive to the given developer, the one or more components to be modified in performing the task and the one or more additional parameters; and
to report the computed time estimate in response to the request.

25. The method according to claim 1, wherein the components include files, projects, systems or devices.

26. The method according to claim 1, wherein retrieving information for each given selected completed software task comprises identifying a commit which completed the task and estimating the task duration based on the time between the identified commit and a most recent previous completed commit of the developer who performed the identified commit.
